(19) United States
(12) Patent Application Publication
(10) Pub. No.: US 2024/0144841 A1
(43) Pub. Date: May 2, 2024

(54) Infant Clock Device

(71) Applicants: Michaela Olsen, Provo, UT (US); Scott Olsen, Provo, UT (US)

(72) Inventors: Michaela Olsen, Provo, UT (US); Scott Olsen, Provo, UT (US)

(21) Appl. No.: 18/180,222

(22) Filed: Mar. 8, 2023

Related U.S. Application Data
(60) Provisional application No. 63/420,769, filed on Oct. 31, 2022.

(51) Int. Cl. G09B 19/12; A63H 33/30

(52) U.S. Cl. CPC G09B 19/12; A63H 33/3066

(57) ABSTRACT

The present invention relates to a clock device. The device is primarily comprised of an infant clock device used for teaching children time and keeping children on schedule. The device is primarily comprised of a body, a plurality of symbols, at least one light, at least one eraser, at least one marker, and at least one remote. The plurality of symbols are comprised of a symbol attachment and a plurality of symbol indicia. The symbol indicia are preferably images and words in order to demonstrate to the children what time a certain activity will be occurring with reference to a specific time shown on the device body.

### CROSS-REFERENCE TO RELATED APPLICATION

The present application claims priority to, and the benefit of, U.S. Provisional Application No. 63/420,769, which was filed on Oct. 31, 2022, and is incorporated herein by reference in its entirety.

### FIELD OF THE INVENTION

The present invention relates generally to the field of clocks. More specifically, the present invention relates to an infant clock device that is comprised of a body, a plurality of symbols, at least one light, at least one eraser, at least one marker, and at least one remote. The plurality of symbols are comprised of a symbol attachment and a plurality of symbol indicia. The symbol indicia are preferably images and words in order to demonstrate to the children what time a certain activity will be occurring with reference to a specific time shown on the device body. Accordingly, the present disclosure makes specific reference thereto. Nonetheless, it is to be appreciated that aspects of the present invention are also equally applicable to other like applications, devices, and methods of manufacture.

### BACKGROUND

Many young children lack the ability to tell time. This inability may leave a child with feelings of constant anxiety due to not knowing what their day will consist of. Constant anxiety can create problems in young children as their brains develops. It can also be stressful for a child to not have a reminder of different activities and tasks throughout the day to do. Parents may have to constantly inform their children what they should be doing at a given time. This not only causes stress on the children, but it can cause stress on the parents as they are having to take time out of their busy schedules to constantly remind their children of the next activity.

Learning to tell the time is typically taught in school and can be taught using a variety of methods. However, said methods can be confusing for children. Children must learn the difference between a digital clock and an analog clock. The analog clock is typically the hardest to learn how to tell the time. If not taught properly in school, the burden of teaching a child how to use an analog clock can fall into the parents adding additional stress to the parents.

Therefore, there exists a long-felt need in the art for an improved infant clock device. There also exists a long-felt need in the art for a device that provides users with a clock device that can point to activity card pictures, showing children what they are to be doing at different times of day. In addition, there exists a long-felt need in the art for a device that teaches children how to read a clock and maintain their busy schedules. Further, there exists a long-felt need in the art for a device that eases anxiety in young children and reduces the number of times parents must remind children what they should be doing throughout the day.

The subject matter disclosed and claimed herein, in one embodiment thereof, comprises an infant clock device. The device is comprised of a body, a plurality of symbols, at least one light, at least one eraser, at least one marker, and at least one remote. In the preferred embodiment, the symbols can be attached to the body. The symbols may be comprised of a plurality of indicia. In the preferred embodiment, the symbol indicia are images and words. In this manner, the user is able to attach the symbols to the body of the device in order to demonstrate to the children what time a certain activity will be occurring with reference to a specific time shown on the device body.

In this manner, the infant clock device of the present invention accomplishes all of the foregoing objectives and provides an improved means for a child clock. Further, the device can help children learn to tell the time while reducing a child's anxiety and stress from not knowing what activities lie ahead for the day.

### SUMMARY

The following presents a simplified summary in order to provide a basic understanding of some aspects of the disclosed innovation. This summary is not an extensive overview, and it is not intended to identify key/critical elements or to delineate the scope thereof. Its sole purpose is to present some general concepts in a simplified form as a prelude to the more detailed description that is presented later.

The subject matter disclosed and claimed herein, in one embodiment thereof, comprises an infant clock device that allows the user to teach children the time while simultaneously keeping the child's stress and anxiety at a minimal level by showing upcoming activities for the day. The device is primarily comprised of a body, a plurality of symbols, at least one light, at least one eraser, at least one marker, and at least one remote. In a differing embodiment, the body may have an appearance of a plurality of shapes. In the preferred embodiment, the body resembles a rectangle. The body may be made of a plurality of materials but is preferably made of a dry erase board material.

The body is comprised of at least one ring fixedly attached to the body, a plurality of clock indicia, and at least one rotator. The ring is fixedly attached to the body as to make a circle to create the appearance of a clock face on the surface of the body. In addition, any surface of the body may be comprised of a plurality of clock indicia such as patterns, logos, emblems, images, symbols, designs, letters, words, characters, animals, advertisements, brands, etc., that may or may not be clock or classroom related. In the preferred embodiment, the clock indicia are the numbers one through twelve.

The rotator is fixedly attached to the body. The rotator is comprised of at least one clock hand which can be rotated three-hundred and sixty degrees. In that manner, a user is able to rotate the clock hand to be placed at any location within the clock face.

In the preferred embodiment, the body is comprised of at least one light and at least one rechargeable battery. The light can be any light known in the art but is preferably a color changing LED light. In this manner, the user can change the lights to different colors to keep children engaged. The light will be powered by the battery. The battery is comprised of a charging port so that the user can recharge the battery for continued use.

In the preferred embodiment, the symbols are comprised of a symbol attachment. The symbol attachment can be any attachment that will allow the symbol to be attached to the body of the device, such as an adhesive or a hook and loop. In the preferred embodiment, the symbol attachment can be a magnet. In addition, any surface of the symbol may be comprised of a plurality of indicia. In the preferred embodiment, the symbol indicia are images and words. In this manner, the user is able to attach the symbols to the body of the device in order to demonstrate to the children what time a certain activity will be occurring.

In the preferred embodiment, the remote is comprised of a plurality of color changers, at least one power button, and at least one remote battery. In a differing embodiment, the remote may not have a power button. The color changers are comprised of a plurality of color options to allow the user to change the color of the lights while the device is in use. The power button allows the user to turn on and off the lights on the device and the remote battery supplies the power to the remote.

Accordingly, the infant clock device of the present invention is particularly advantageous as it provides users with a clock device that can teach children how to read a clock while pointing to activity card pictures which shows children what they are to be doing at different times of day. In addition, the infant clock device eases anxiety in young children and reduces the number of times parents must remind children what they should be doing throughout the day. In this manner, the infant clock device overcomes the limitations of existing clocks known in the art.

To the accomplishment of the foregoing and related ends, certain illustrative aspects of the disclosed innovation are described herein in connection with the following description and the annexed drawings. These aspects are indicative, however, of but a few of the various ways in which the principles disclosed herein can be employed and are intended to include all such aspects and their equivalents. Other advantages and novel features will become apparent from the following detailed description when considered in conjunction with the drawings.

### BRIEF DESCRIPTION OF THE DRAWINGS

The description refers to provided drawings in which similar reference characters refer to similar parts throughout the different views, and in which:

FIG. 1 illustrates a front perspective view of one potential embodiment of an infant clock device of the present invention in accordance with the disclosed architecture;

FIG. 2 illustrates a perspective view of one potential embodiment of an infant clock device of the present invention in accordance with the disclosed architecture; and

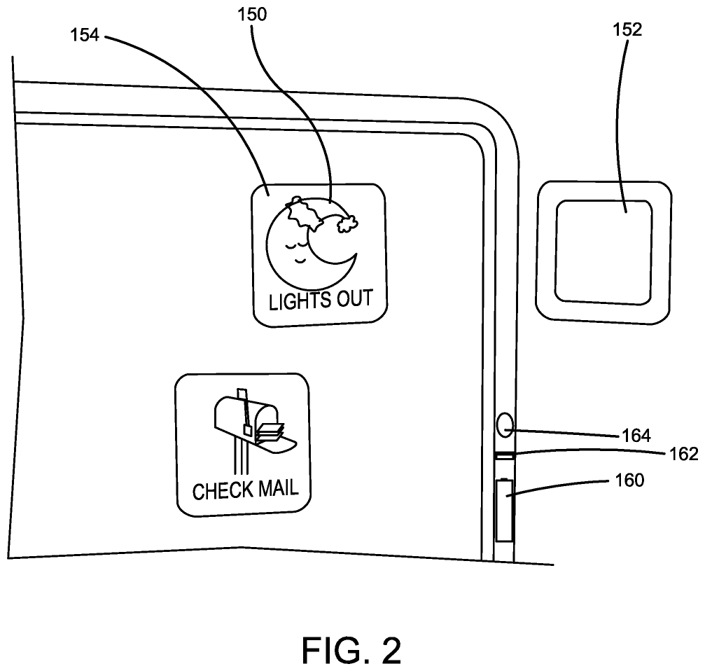

FIG. 3 illustrates a front perspective view of one potential embodiment of an infant clock device of the present invention in accordance with the disclosed architecture.

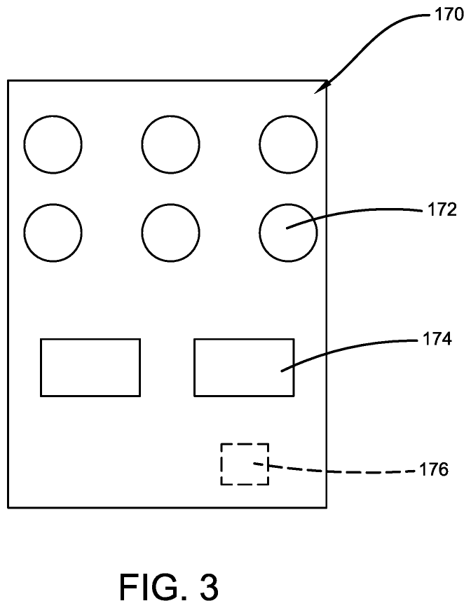

### DETAILED DESCRIPTION

The innovation is now described with reference to the drawings, wherein like reference numerals are used to refer to like elements throughout. In the following description, for purposes of explanation, numerous specific details are set forth in order to provide a thorough understanding thereof. It may be evident, however, that the innovation can be practiced without these specific details. In other instances, well-known structures and devices are shown in block diagram form in order to facilitate a description thereof. Various embodiments are discussed hereinafter. It should be noted that the figures are described only to facilitate the description of the embodiments. They are not intended as an exhaustive description of the invention and do not limit the scope of the invention. Additionally, an illustrated embodiment need not have all the aspects or advantages shown. Thus, in other embodiments, any of the features described herein from different embodiments may be combined.

As noted above, there exists a long-felt need in the art for an improved infant clock device. There also exists a long-felt need in the art for a device that provides users with a clock device that can point to activity card pictures, showing children what they are to be doing at different times of day. In addition, there exists a long-felt need in the art for a device that functions as a way to teach children how to read a clock and maintain their busy schedules. Further, there exists a long-felt need in the art for a device that eases anxiety in young children and reduces the number of times parents must remind children what they should be doing throughout the day.

The present invention, in one exemplary embodiment, is comprised of an infant clock device that allows the user to teach children the time while simultaneously keeping the child's stress and anxiety at a minimal level by showing upcoming activities for the day. The device is primarily comprised of a body, a plurality of symbols, at least one light, at least one eraser, at least one marker, and at least one remote. In a differing embodiment, the body may have an appearance of a plurality of shapes, and in the preferred embodiment the body resembles a rectangle. The body may be made of a plurality of materials but is preferably made of a dry erase board material.

The body is comprised of at least one ring fixedly attached to the body, a plurality of clock indicia, and at least one rotator. The ring is fixedly attached to the body as to make a circle to create the appearance of a clock face on the surface of the body. In addition, any surface of the body may be comprised of a plurality of clock indicia such as patterns, logos, emblems, images, symbols, designs, letters, words, characters, animals, advertisements, brands, etc., that may or may not be clock or classroom related. In the preferred embodiment, the clock indicia are the numbers one through twelve.

The rotator is fixedly attached to the body and is comprised of at least one clock hand and allows the user to rotate the clock hand three-hundred and sixty degrees. In that manner, a user is able to rotate the clock hand to be placed at any location within the clock face.

In the preferred embodiment, the body is comprised of at least one light and at least one rechargeable battery. The light can be any light known in the art but is preferably a color changing LED light. In this manner, the user can change the lights to different colors to keep children engaged. The light will be powered by the battery. The battery is comprised of a charging port so that the user can recharge the battery for continued use.

In the preferred embodiment, the symbols are comprised of a symbol attachment. The symbol attachment can be any attachment that will allow the symbol to be attached to the body of the device, such as an adhesive or a hook and loop. In the preferred embodiment, the symbol attachment can be a magnet. In addition, any surface of the symbol may be comprised of a plurality of indicia. In the preferred embodiment, the symbol indicia are images and words. In this manner, the user is able to attach the symbols to the body of the device in order to demonstrate to the children what time a certain activity will be occurring.

In the preferred embodiment, the remote is comprised of a plurality of color changers, at least one power button, and at least one remote battery. In a differing embodiment, the remote may not have a power button. The color changers are comprised of a plurality of color options to allow the user to change the color of the lights while the device is in use. The power button allows the user to turn on and off the lights on the device and the remote battery supplies the power to the remote.

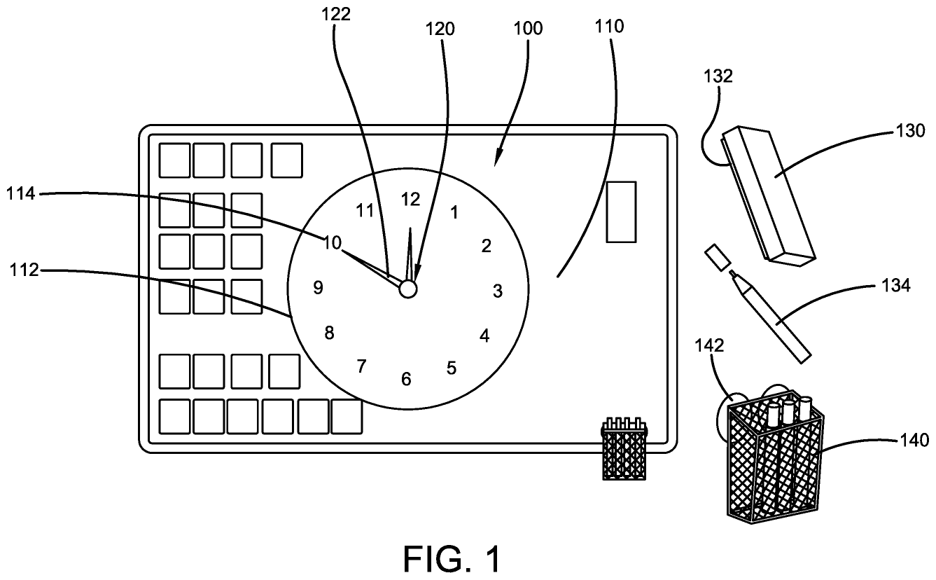

Referring initially to the drawings, FIG. 1 illustrates a front perspective view of one potential embodiment of an infant clock device 100 of the present invention in accordance with the disclosed architecture. The device 100 is primarily comprised of a body 110, a plurality of symbols 150, at least one light 164, at least one eraser 132, at least one marker 134, and at least one remote 170. In a differing embodiment, the body 110 may have an appearance of a plurality of shapes such as a circle, a square, an oval, etc. In the preferred embodiment, the body 110 resembles a rectangle. The body 110 may be made of a plurality of materials known in the art that allow a user to write and erase but is preferably made of a dry erase board material that may be magnetic.

The body 110 is comprised of at least one ring 112 fixedly attached to the body, a plurality of indicia 114, and at least one rotator 120. The ring 112 is fixedly attached to the body 110 as to make a circle to create the appearance of a clock face on the body 110. The ring 112 may be adhesively secured to the body 110. In addition, any surface of the body 110 may be comprised of a plurality of clock indicia 114 such as patterns, logos, emblems, images, symbols, designs, letters, words, characters, animals, advertisements, brands, etc., that may or may not be clock or classroom related. In the preferred embodiment, the clock indicia 114 are the numbers 1-12.

The rotator 120 is fixedly attached to the body 110 and is comprised of at least one clock hand 122. In one embodiment, the rotator 120 is simply a rotational pivot point such as but not limited to a pin. In another embodiment, the rotator 120 is any clock mechanism known in the art that rotates the hand 122. The rotator 120 in this embodiment may be powered by a battery 160. The clock hand 122 can rotate three-hundred and sixty degrees. In this manner, a user is able to rotate the clock hand 122 to be placed at any location within the clock face 112. In the preferred embodiment, the rotator 120 and clock hand 122 are made of a rigid plastic such as, but not limited to, acrylic, polycarbonate, polyethylene, thermoplastic, acrylonitrile butadiene styrene, low density polyethylene, medium density polyethylene, high density polyethylene, polyethylene terephthalate, polyvinyl chloride, polystyrene, polylactic acid, acetal, nylon, fiberglass, etc. In differing embodiments, the rotator 120 and the clock hand 122 can be made of a lightweight metal such as aluminum.

In the preferred embodiment, the body 110 is comprised of at least one light 164 and at least one battery 160. The light 164 can be any light known in the art but is preferably a color changing LED light. In differing embodiments, the light 164 may be a compact fluorescent lamp, a halogen lamp, an incandescent bulb, etc. In this manner, the user can change the light 164 to different colors to keep children engaged. The light 164 will be powered by the battery 160. The battery 160 may be a disposable battery 160 or a rechargeable battery 160 in the form of an alkaline, nickel-cadmium, nickel-metal hydride battery 160, etc., such as any 3V-12 volts DC battery 160 or other conventional battery 160 such as A, AA, AAA, etc., that supplies power to the light 164. Throughout this specification, the terms “battery” and “batteries” may be used interchangeably to refer to one or more wet or dry cells or batteries 160 of cells in which chemical energy is converted into electricity and used as a source of DC power. References to recharging or replacing batteries 160 may refer to recharging or replacing individual cells, individual batteries 160 of cells, or a package of multiple battery cells as is appropriate for any given battery 160 technology that may be used.

The battery 160 may be comprised of at least one charging port 162. In the preferred embodiment, the charging port 162 may be a USB port. In this manner, the user will be able to recharge the battery 160 so that the light 164 can maintain its function. In differing embodiments, the charging port 162 can be any charging port known in the art such as, but not limited to, a USB—A port, a USB-B port, a micro-USB port, a mini-USB port, a USB-C port, a lightning port, etc.

In the preferred embodiment, the eraser 132 is comprised of an eraser grip 130. The eraser 132 can be any eraser known in the art that can remove dry erase marker ink from the surface of the body 110. In the preferred embodiment, the eraser grip 130 is a rigid foam that allows the user a location to grasp the eraser while in use. In a differing embodiment, the eraser grip 130 may be a rigid plastic.

In the preferred embodiment, the marker 134 is a dry erase marker. In differing embodiments, the marker 134 may be any marker that is capable of being erased once used.

In the preferred embodiment, the marker holder 140 is comprised of at least one holder attachment 142. The marker holder 140 may be made of a metal material such as aluminum or aluminum alloys. In differing embodiments, the marker holder 140 may be made of a rigid plastic material. In the preferred embodiment, the holder attachment 142 is a suction cup that attaches to the side of the body 110. In differing embodiments, the holder attachment 142 may be an adhesive or a magnet.

In the preferred embodiment, the symbols 150 are comprised of a symbol attachment 152. The symbol attachment 152 can be any fastener that will allow the symbols 150 to be attached to the body 110 of the device such as, but not limited to, an adhesive fastener, a magnetic fastener, or a hook and loop fastener. In the preferred embodiment, the symbol attachment 152 can be a magnet. In addition, any surface of the symbols 150 may be comprised of a plurality of symbol indicia 154. The symbol indicia 154 may be any indicia such as patterns, logos, emblems, symbols, designs, letters, characters, animals, advertisements, brands, etc., that may or may not be clock or classroom related. In the preferred embodiment, the symbol indicia 154 are images and words that may relate to a task or an activity. In this manner, the user is able to attach the symbols 150 to the body 110 of the device 100 in order to demonstrate to the children what time a certain activity will be occurring based on the symbol indicia 154 shown in the symbols 150.

In the preferred embodiment, the remote 170 is comprised of a plurality of color changers 172, at least one power button 174, and at least one remote battery 176. In a differing embodiment, the remote 170 may not have a power button 174. In the preferred embodiment, the remote may be made of a rigid plastic material. The color changers 172 are comprised of a plurality of color options such as, but not limited to, red, orange, yellow, green, blue, purple, etc., that allow the user to change the color of the lights 164 while the device 100 is in use. The power button 174 allows the user to turn on and off the lights 164 on the device 100 and the remote battery 176 supplies the power to the remote. In the preferred embodiment, the remote battery 176 is a disposable battery.

Certain terms are used throughout the following description and claims to refer to particular features or components. As one skilled in the art will appreciate, different persons may refer to the same feature or component by different names. This document does not intend to distinguish between components or features that differ in name but not structure or function. As used herein “infant clock device” and “device” are interchangeable and refer to the infant clock device 100 of the present invention.

Notwithstanding the foregoing, the infant clock device 100 of the present invention and its various components can be of any suitable size and configuration as is known in the art without affecting the overall concept of the invention, provided that they accomplish the above-stated objectives. One of ordinary skill in the art will appreciate that the size, configuration, and material of the infant clock device 100 as shown in the FIGS. are for illustrative purposes only, and that many other sizes and shapes of the infant clock device 100 are well within the scope of the present disclosure. Although the dimensions of the infant clock device 100 are important design parameters for user convenience, the infant clock device 100 may be of any size, shape and/or configuration that ensures optimal performance during use and/or that suits the user's needs and/or preferences.

Various modifications and additions can be made to the exemplary embodiments discussed without departing from the scope of the present invention. While the embodiments described above refer to particular features, the scope of this invention also includes embodiments having different combinations of features and embodiments that do not include all of the described features. Accordingly, the scope of the present invention is intended to embrace all such alternatives, modifications, and variations as fall within the scope of the claims, together with all equivalents thereof.

What has been described above includes examples of the claimed subject matter. It is, of course, not possible to describe every conceivable combination of components or methodologies for purposes of describing the claimed subject matter, but one of ordinary skill in the art may recognize that many further combinations and permutations of the claimed subject matter are possible. Accordingly, the claimed subject matter is intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. An infant clock device comprising:
a body;
a clock hand;
a clock indicia; and
a symbol comprised of a fastener.

2. The infant clock device of claim 1, wherein the body is comprised of a magnetic body.

3. The infant clock device of claim 1, wherein the fastener is comprised of a magnetic fastener.

4. The infant clock device of claim 1, wherein the symbol is comprised of an image.

5. The infant clock device of claim 4, wherein the image represents a task.

6. The infant clock device of claim 1, wherein the clock indicia is comprised of a number.

7. An infant clock device comprising:
a body;
a clock hand;
a clock indicia;
a symbol comprised of a fastener and a symbol indicia;
a marker;
a marker holder; and
an eraser.

8. The infant clock device of claim 7, wherein the body is comprised of a light.

9. The infant clock device of claim 8, wherein the light is powered by a battery.

10. The infant clock device of claim 9, wherein the battery is comprised of a charging port.

11. The infant clock device of claim 8, wherein the light is controlled by a remote.

12. An infant clock device comprising:
a body;
a clock hand;
a ring;
a clock indicia;
a symbol comprised of a first fastener and a symbol indicia;
a marker;
a marker holder comprised of a second fastener; and
an eraser.

13. The infant clock device of claim 12, wherein the clock indicia is comprised of a pattern, a logo, an emblem, a symbol, a design, a letter, a character, an animal, an advertisement, or a brand.

14. The infant clock device of claim 12, wherein the second fastener is comprised of a suction cup.

15. The infant clock device of claim 12, wherein the second fastener is comprised of a magnet.

16. The infant clock device of claim 12, wherein the body is comprised of a dry erase material.

17. The infant clock device of claim 12, wherein the marker is comprised of a dry erase marker.

18. The infant clock device of claim 12, wherein the eraser is comprised of a grip.

19. The infant clock device of claim 12 further comprised of a clock ring.

20. The infant clock device of claim 19, wherein the clock ring is removably attached to the body.
